(19) United States
(12) Patent Application Publication
(10) Pub. No.: US 2024/0228702 A1
(43) Pub. Date: Jul. 11, 2024

(54) GLASS COMPONENT

(71) Applicant: SAKAMOTO YAKUHIN KOGYO CO., LTD., Osaka (JP)

(72) Inventors: Yukiko TANIHATA, Osaka (JP); Yuka KAKIKURA, Osaka (JP); Shiori HARADA, Osaka (JP); Shizuki MONDA, Osaka (JP); Kimihiro MATSUKAWA, Osaka (JP)

(73) Assignee: SAKAMOTO YAKUHIN KOGYO CO., LTD., Osaka (JP)

(21) Appl. No.: 18/561,340

(22) PCT Filed: May 20, 2022
(86) PCT No.: PCT/JP2022/020942

§ 371 Date: Nov. 16, 2023

(30) Foreign Application Priority Data
May 20, 2021 (JP) 2021-085697

(51) Int. Cl. C08G 65/336; C07F 7/18; C08G 65/26

(52) U.S. Cl. CPC C08G 65/336; C07F 7/1892; C08G 65/2609

(57) ABSTRACT

A compound having a (poly)glycerin skeleton with an average degree of polymerization of 1-100, and which contains a (poly)glycerin-based alkoxysilane having an alkoxysilyl group.

### TECHNICAL FIELD

The present invention relates to a glass component used for flexible glass, a coating film, and the like.

### BACKGROUND ART

In recent years, electronic devices and display devices represented by personal computers and mobile phones have made rapid progress. Along with this, not only thinning and weight reduction of the device but also flexibility are particularly required. In these devices, various electronic elements, for example, a thin film transistor, a transparent electrode, and the like are provided on a substrate. Here, by using a flexible and lightweight material for the glass component constituting the substrate, it is expected to achieve thinning and weight reduction, and flexibility of the device itself.

In general, inorganic materials have high dimensional stability but are heavy and have low flexibility. On the other hand, organic materials have features such as light weight and good processability, but there is a concern about insufficient strength. Therefore, for example, an organic-inorganic hybrid material having both characteristics of an inorganic material and an organic material is known (see Patent Literature 1).

In addition, a coating film that can maintain flexibility even when the film thickness is equal to or larger than a certain value by containing an organic polysilazane, an alkyl silicate condensate, and an organic solvent is known (see Patent Literature 2).

### CITATION LIST

### Patent Literature

Patent Literature 1: WO 2019/139167 A
Patent Literature 2: JP 2021-014514 A

### SUMMARY OF INVENTION

### Technical Problem

Meanwhile, glycerol has attracted attention as a biomass raw material in consideration of environment and safety, and is expected to be widely used not only in cosmetics, foods, and pharmaceuticals but also in industrial applications. The present applicant has been conducting research and development of glycerol for a long time, and has developed a glass component for a substrate using a polyglycerin-based compound. An object of the present invention is to provide a glass component having excellent flexibility when used for flexible glass, a coating film, or the like.

### Solution to Problem

In order to solve the above problems, the present invention is a glass component which is a compound having a (poly)glycerol skeleton with an average polymerization degree of 1 to 100 and contains a (poly)glycerin-based alkoxysilane having an alkoxysilyl group.

### Advantageous Effects of Invention

The cured product obtained by curing the glass component had no breakage and cracks with respect to bending, and was excellent in flexibility. Therefore, the glass component of the present invention can be applied to flexible glass and coating materials.

### DESCRIPTION OF EMBODIMENTS

Hereinafter, the present invention will be described based on embodiments. Here, the scope of the present invention is not limited to the following embodiments, and includes modified forms without impairing the gist of the present invention. Here, the term “to” representing a range includes an upper limit and a lower limit.

The present invention is a glass component which is a compound having a (poly)glycerol skeleton with an average polymerization degree of 1 to 100 and contains a (poly)glycerin-based alkoxysilane having an alkoxysilyl group. Preferably, the present invention is a glass component containing a (poly)glycerin-based alkoxysilane having a plurality of alkoxysilyl groups at the terminal of the (poly)glycerol skeleton. Here, the (poly)glycerol represents glycerol or polyglycerol.

The average polymerization degree of (poly)glycerol according to the present invention is 1 to 100, the lower limit is preferably 2 or more, and more preferably 4 or more, and the upper limit is preferably 70 or less, more preferably 20 or less, and most preferably 15 or less. Here, the average polymerization degree is calculated from the following formulas (2) and (3) from a hydroxyl value by terminal analysis method. The hydroxyl value in the formula (3) is a numerical value serving as an index of the magnitude of the number of hydroxyl groups contained in (poly)glycerol, and refers to the number of milligrams of potassium hydroxide required to neutralize acetic acid necessary for acetylating free hydroxyl groups contained in 1 g of (poly)glycerol. The number of milligrams of potassium hydroxide is calculated in accordance with “Standard Method for Analytical Test of Fats and Oils, established by The Japan Oil Chemists' Society, 2013 edition” edited by The Japan Oil Chemists' Society.

$$Molecular weight = 74 n + 18 \qquad ( 2 )$$

$$Hydroxyl value = 56110 ( n + 2 ) / Molecular weight \qquad ( 3 )$$

The (poly)glycerin-based alkoxysilane according to the present invention is preferably a reaction product obtained by reacting (poly)glycerol or a (poly)glycerol derivative with a compound having an alkoxysilyl group.

The (poly)glycerol or the (poly)glycerol derivative is preferably a compound represented by a structure of the following formula (1).

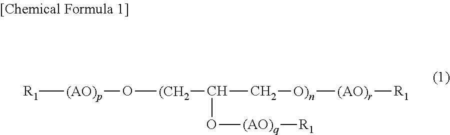

wherein n, p, q, and r each represent the number of repeating units, n is an integer of 1 to 100, and p, q, and r each are an integer of 0 to 50, AO represents an alkylene oxide having 1 to 4 carbon atoms, R1 is the same or different functional group, and is any reactive functional group selected from the group consisting of hydrogen, a thiol group, a (meth)acryloyl group, an epoxy group, and an allyl group, or a substituent containing the reactive functional group.

Examples of AO include ethylene oxide (EO), propylene oxide (PO), and butylene oxide (BO), and ethylene oxide (EO) is preferable. In the formula (1), p, q, and r each represent the average number of alkylene oxide added to one hydroxyl group of polyglycerol, and are each preferably 0 to 50 and more preferably 1 to 20. Also, the sum of p, q, and r (p+q+r) is preferably 1 to 130, and more preferably 5 to 120.

Specific examples of the (poly)glycerol or (poly)glycerol derivative include (poly)glycerols, (poly)glycerol alkylene oxide adducts, (poly)glycerol (alkylene oxide) thioglycolates, (poly)glycerol (alkylene oxide) 3-mercaptopropionates, (poly)glycerol (alkylene oxide) (meth)acrylates, (poly)glycerol (alkylene oxide) (poly)glycidyl ethers, (poly)glycerol (alkylene oxide) (poly)allyl ethers, and the like.

The compound having an alkoxysilyl group is, for example, an alkoxysilane having a vinyl group, an allyl group, an isocyanate group, a thiol group, a (meth)acryloyl group, an epoxy group, a hydroxyl group, an amino group, a hydrosilyl group, or the like, and specific examples thereof include trimethoxysilane, triethoxysilane, vinyltrimethoxysilane, vinyltriethoxysilane, 3-isocyanatopropyltriethoxysilane, 3-isocyanatepropyltrimethoxysilane, 3-mercaptopropylmethyldimethoxysilane, 3-mercaptopropyltrimethoxysilane, 3-methacryloxypropyltrimethoxysilane, 3-methacryloxypropylmethyldiethoxysilane, 3-acryloxypropyltrimethoxysilane, 3-glycidoxypropyltrimethoxysilane, 3-glycidoxypropylmethyldiethoxysilane, N-2-(aminoethyl)-3-aminopropylmethyldimethoxysilane, 3-aminopropyltriethoxysilane, 3-hydroxypropyltriethoxysilane, 3-aminopropyltriethoxysilane and the like.

The (poly)glycerin-based alkoxysilane according to the present invention is preferably obtained by reacting a reactive functional group contained in the (poly)glycerol or the (poly)glycerol derivative with a reactive functional group contained in the alkoxysilane. Specific examples thereof include a reaction product of (poly)glycerol, a (poly)glycerol alkylene oxide adduct, or a (poly)glycerol derivative having a thiol group with an alkoxysilane containing any of a vinyl group, an isocyanate group, an epoxy group, and an amino group, a reaction product of a (poly)glycerol derivative having a (meth)acryloyl group or a (poly)glycerol derivative having an allyl group with an alkoxysilane having any of a vinyl group, an allyl group, a thiol group, a (meth)acryloyl group, and a hydrosilyl group, a reaction product of a (poly)glycerol derivative having an epoxy group with an alkoxysilane containing any of a thiol group, a hydroxyl group, and a hydrosilyl group, and the like. In the obtained reaction products, it is preferable that 20 to 100% of the reactive functional groups of the (poly)glycerol or the (poly)glycerol derivative are reacted and bonded, and it is further preferable that 50 to 100% of the reactive functional groups are reacted and bonded.

The glass component of the present invention is a compound having a (poly)glycerol skeleton with an average polymerization degree of 1 to 100 and contains a (poly)glycerin-based alkoxysilane having an alkoxysilyl group. The glass component of the present invention also includes those containing an organic/inorganic compound as long as the effect of the present invention is not impaired.

The glass component of the present invention can be used for preparing a cured coating film by being applied to various substrates and cured. The method for curing the coating film is not particularly limited, but for example, curing by sol-gel reaction is preferable.

When the glass component of the present invention is cured by sol-gel reaction, water necessary for hydrolysis of a metal alkoxide is added. In addition, it is preferable to use a catalyst for accelerating the hydrolysis and polycondensation reaction of the metal alkoxide, and examples of the catalyst include an acid catalyst and an alkali catalyst used in the conventional sol-gel method. Examples of the acid catalyst include hydrochloric acid, nitric acid, sulfuric acid, formic acid, organic acid, photoacid generators, and the like. Also, examples of the alkali catalyst include inorganic base compounds such as metal hydroxides and ammonia, organic base compounds such as amines and phosphines, photobase generators, and the like.

The coating method for preparing a coating film using the glass component of the present invention is not particularly limited, and examples thereof include a cast coating method, a spin coating method, a blade coating method, a dip coating method, a roll coating method, a bar coating method, a die coating method, and the like.

The film thickness of the coating film can be appropriately changed to 0.1 to 100 μm according to the application. In general, a sol-gel film with a large proportion of an inorganic component is considered to be difficult to mold a thick film with a thickness of 1 μm or more because cracks easily occur. However, in the glass component of the present invention, since the (poly)glycerin-based alkoxysilane has a flexible skeleton structure, it is possible to mold a thick film with a thickness of 30 μm or more.

When the present invention is cured, other additives may be added as long as the effects of the present invention are not impaired. Examples of such additives include ultraviolet absorbers, colorants, pigments, antioxidants, anti-yellowing agents, bluing agents, antifoaming agents, thickeners, anti-settling agents, antistatic agents, surfactants, adhesion promoters, infrared absorbers, light stabilizers, and the like.

Furthermore, an organic solvent may be mixed. For example, alcohols include methanol, ethanol, butanol, isobutanol, isopropyl alcohol, propanol, t-butanol, sec-butanol, and benzyl alcohol, ketones include acetone, methyl ethyl ketone, methyl isobutyl ketone, diisobutyl ketone, cyclohexanone, and diacetone alcohol, esters include ethyl acetate, methyl acetate, butyl acetate, sec-butyl acetate, methoxybutyl acetate, amyl acetate, propyl acetate, isopropyl acetate, ethyl lactate, methyl lactate, and butyl lactate, ethers include isopropyl ether, methyl cellosolve, ethyl cellosolve, and butyl cellosolve, glycols include ethylene glycol, diethylene glycol, triethylene glycol, and propylene glycol, glycol esters include ethylene glycol monoethyl ether acetate, methoxypropyl acetate, butyl carbitol acetate, and ethyl carbitol acetate, glycol ethers include diethylene glycol monomethyl ether, diethylene glycol monoethyl ether, and butyl diglycol, methyl triglycol, propylene glycol monomethyl ether (PGM), propylene glycol monomethyl ether acetate (PGMEA), propylene glycol monobutyl ether, 3-methoxy-3-methyl-1 butanol, diethylene glycol monohexyl ether, propylene glycol monomethyl ether propionate, dipropylene glycol methyl ether, ethylene glycol dimethyl ether, diethylene glycol dimethyl ether, ethylene glycol diethyl ether, and diethylene glycol diethyl ether, and aromatic hydrocarbon-based compounds include benzene, toluene, and xylene. These organic solvents can be used singly or in combination of two or more kinds thereof.

In particular, in order to increase crosslinking density, for example, silicate monomers such as TMOS and TEOS, silicate oligomers such as methyl silicate and ethyl silicate, polysilsesquioxane, and the like can be blended.

Examples of the substrate to apply the glass component of the present invention include glass, polyethylene terephthalate, polycarbonate, plastics such as acrylic, metals, rock, and the like.

The coating film prepared from the glass component of the present invention is used for coating, for example, windshields, lamp covers, camera lenses, goggles, and the like of automobiles. In addition, since the coating film has bending resistance, the coating film can be used for a touch panel display, an electronic paper, an organic EL illumination, a substrate glass for a solar cell, a member of a flexible device, and the like.

### EXAMPLES

Hereinafter, the present invention will be described with reference to examples, but the present invention is not limited thereto at all.

### Synthesis Example 1

A reaction vessel equipped with a thermometer, a stirrer, and a Dean-Stark apparatus was charged with 764 g of EO 60 mol adduct of tetraglycerol (polyglycerin having an average polymerization degree of 4), 163 g of 3-mercaptopropionic acid, 900 g of toluene, and 45 g of p-toluenesulfonic acid, the temperature was raised to a toluene reflux atmosphere with stirring, and a dehydration condensation reaction was performed over about 6 hours. After completion of the reaction, the reaction mixture was neutralized using sodium hydrogen carbonate, and extracted with ethyl acetate:toluene=50:50. The organic layer of the solvent after extraction was distilled off under reduced pressure to obtain 367 g of 3-mercaptopropionate ester as EO 60 mol adduct of tetraglycerol. A reaction vessel equipped with a stirrer was charged with 319 g of 3-mercaptopropionate ester of EO 60 mol adduct of tetraglycerol and 81 g of vinyltrimethoxysilane, and the mixture was stirred for 45 minutes while being irradiated with UV light to obtain 400 g of an alkoxysilane compound A1. Incidentally, 100% of the hydroxyl groups at the terminals of the polyglycerol derivative were reacted.

### Synthesis Example 2

A reaction vessel equipped with a thermometer and a stirrer was charged with 425 g of EO 60 mol adduct of tetraglycerol, 210 g of 3-isocyanatopropyltriethoxysilane (manufactured by TCI), and 0.13 g of dibutyltin dilaurate, and the mixture was stirred at 40° C. for 4 hours to obtain 635 g of an alkoxysilane compound (A2). Incidentally, 100% of the hydroxyl groups at the terminals of the polyglycerol derivative were reacted.

### Synthesis Example 3

A reaction vessel equipped with a thermometer and a stirrer was charged with 66 g of EO 40 mol adduct of diglycerol, 34 g of 3-isocyanatopropyltriethoxysilane (manufactured by TCI), and 0.01 g of dibutyltin dilaurate, and the mixture was stirred at 60° C. for 12 hours to obtain 100 g of an alkoxysilane compound (A3). Incidentally, 100% of the hydroxyl groups at the terminals of the polyglycerol derivative were reacted.

### Synthesis Example 4

A reaction vessel equipped with a thermometer and a stirrer was charged with 66 g of EO 120 mol adduct of decaglycerol, 34 g of 3-isocyanatopropyltriethoxysilane (manufactured by TCI), and 0.01 g of dibutyltin dilaurate, and the mixture was stirred at 40° C. for 4 hours to obtain 100 g of an alkoxysilane compound (A4). Incidentally, 100% of the hydroxyl groups at the terminals of the polyglycerol derivative were reacted.

### Synthesis Example 5

A reaction vessel equipped with a thermometer and a stirrer was charged with 28 g of EO 6 mol adduct of tetraglycerol, 72 g of 3-isocyanatopropyltriethoxysilane (manufactured by TCI), and 0.01 g of dibutyltin dilaurate, and the mixture was stirred at 60° C. for 11 hours to obtain 100 g of an alkoxysilane compound (A5). Incidentally, 100% of the hydroxyl groups at the terminals of the polyglycerol derivative were reacted.

### Synthesis Example 6

A reaction vessel equipped with a thermometer and a stirrer was charged with 29 g of EO 7 mol adduct of tetraglycerol, 71 g of 3-isocyanatopropyltriethoxysilane (manufactured by TCI), and 0.01 g of dibutyltin dilaurate, and the mixture was stirred at 60° C. for 6 hours to obtain 100 g of an alkoxysilane compound (A6). Incidentally, 100% of the hydroxyl groups at the terminals of the polyglycerol derivative were reacted.

### Synthesis Example 7

A reaction vessel equipped with a thermometer and a stirrer was charged with 31 g of EO 8 mol adduct of tetraglycerol, 69 g of 3-isocyanatopropyltriethoxysilane (manufactured by TCI), and 0.01 g of dibutyltin dilaurate, and the mixture was stirred at 60° C. for 5 hours to obtain 100 g of an alkoxysilane compound (A7). Incidentally, 100% of the hydroxyl groups at the terminals of the polyglycerol derivative were reacted.

### Synthesis Example 8

A reaction vessel equipped with a thermometer and a stirrer was charged with 37 g of EO 12 mol adduct of tetraglycerol, 63 g of 3-isocyanatopropyltriethoxysilane (manufactured by TCI), and 0.01 g of dibutyltin dilaurate, and the mixture was stirred at 60° C. for 5 hours to obtain 100 g of an alkoxysilane compound (A8). Incidentally, 100% of the hydroxyl groups at the terminals of the polyglycerol derivative were reacted.

### Synthesis Example 9

A reaction vessel equipped with a thermometer and a stirrer was charged with 44 g of EO 12 mol adduct of tetraglycerol, 56 g of 3-isocyanatopropyltriethoxysilane (manufactured by TCI), and 0.01 g of dibutyltin dilaurate, and the mixture was stirred at 60° C. for 2 hours to obtain 100 g of an alkoxysilane compound (A9). Incidentally, 75% of the hydroxyl groups at the terminals of the polyglycerol derivative were reacted.

### Synthesis Example 10

A reaction vessel equipped with a thermometer and a stirrer was charged with 54 g of EO 12 mol adduct of tetraglycerol, 46 g of 3-isocyanatopropyltriethoxysilane (manufactured by TCI), and 0.01 g of dibutyltin dilaurate, and the mixture was stirred at 60° C. for 2 hours to obtain 100 g of an alkoxysilane compound (A10). Incidentally, 50% of the hydroxyl groups at the terminals of the polyglycerol derivative were reacted.

### Synthesis Example 11

A reaction vessel equipped with a thermometer and a stirrer was charged with 73 g of EO 60 mol adduct of tetraglycerol, 27 g of 3-isocyanatopropyltriethoxysilane (manufactured by TCI), and 0.01 g of dibutyltin dilaurate, and the mixture was stirred at 60° C. for 12 hours to obtain 100 g of an alkoxysilane compound (A11). Incidentally, 75% of the hydroxyl groups at the terminals of the polyglycerol derivative were reacted.

### Synthesis Example 121

A reaction vessel equipped with a thermometer and a stirrer was charged with 80 g of EO 60 mol adduct of tetraglycerol, 20 g of 3-isocyanatopropyltriethoxysilane (manufactured by TCI), and 0.01 g of dibutyltin dilaurate, and the mixture was stirred at 60° C. for 6 hours to obtain 100 g of an alkoxysilane compound (A12). Incidentally, 50% of the hydroxyl groups at the terminals of the polyglycerol derivative were reacted.

### Synthesis Example 13

A reaction vessel equipped with a thermometer and a stirrer was charged with 10 g of EO 12 mol adduct of tetraglycerol, 16.7 g of a 50% aqueous thorium hydroxide solution, and 2.24 g of tetrabutylammonium bromide, and the mixture was stirred at 40° C. Thereto was added dropwise 25.3 g of allyl bromide, and the mixture was stirred for 22 hours while being heated at 40° C. After completion of the reaction, the mixture was extracted with toluene, and the solvent was distilled off under reduced pressure to synthesize allyl ether of EO 12 mol adduct of tetraglycerol. Subsequently, 10.0 g of allyl ether of EO 12 mol adduct of tetraglycerol and 6.22 g of triethoxysilane were charged, and the mixture was stirred at room temperature in the presence of Karstedt's catalyst to obtain 16 g of an alkoxysilane compound (A13). Incidentally, 100% of the hydroxyl groups at the terminals of the polyglycerol derivative were reacted.

### Synthesis Example 14

A reaction vessel equipped with a thermometer and a stirrer was charged with 4.5 g of an acrylate of EO 12 mol adduct of tetraglycerol, 5.5 g of 3-mercaptopropyltriethoxysilane (manufactured by TCI), and 0.05 g of diethylamine, and the mixture was stirred at 40° C. for 2 hours. After completion of the reaction, 10 mL of toluene was added, and toluene and diethylamine were distilled off under reduced pressure to obtain 10 g of an alkoxysilane compound (A14).

### Synthesis Example 15

A reaction vessel equipped with a thermometer and a stirrer was charged with 56.6 g of allyl ether of EO 12 mol adduct of tetraglycerol and 73.3 g of 3-mercaptopropyltriethoxysilane (manufactured by TCI), and the mixture was stirred at room temperature for 1.5 hours while being irradiated with ultraviolet rays (wavelength: 365 nm) to obtain 130 g of an alkoxysilane compound (A15). Incidentally, 100% of the hydroxyl groups at the terminals of the polyglycerol derivative were reacted.

### Synthesis Example 16

A reaction vessel equipped with a thermometer and a stirrer was charged with 50.0 g of EO 8 mol adduct of diglycerol, 85.7 g of 3-isocyanatopropyltriethoxysilane (manufactured by TCI), and 0.013 g of dibutyltin dilaurate, and the mixture was stirred at 60° C. for 15 hours to obtain 131 g of an alkoxysilane compound (A16). Incidentally, 100% of the hydroxyl groups at the terminals of the polyglycerol derivative were reacted.

### Synthesis Example 17

A reaction vessel equipped with a thermometer and a stirrer was charged with 13.8 g of EO 10 mol adduct of triglycerol, 25.8 g of 3-isocyanatopropyltriethoxysilane (manufactured by TCI), and 0.004 g of dibutyltin dilaurate, and the mixture was stirred at 60° C. for 18 hours to obtain 40 g of an alkoxysilane compound (A17). Incidentally, 100% of the hydroxyl groups at the terminals of the polyglycerol derivative were reacted.

### Synthesis Example 18

A reaction vessel equipped with a thermometer and a stirrer was charged with 50.0 g of EO 24 mol adduct of decaglycerol, 82.0 g of 3-isocyanatopropyltriethoxysilane (manufactured by TCI), and 0.013 g of dibutyltin dilaurate, and the mixture was stirred at 60° C. for 15 hours to obtain 132 g of an alkoxysilane compound (A18). Incidentally, 100% of the hydroxyl groups at the terminals of the polyglycerol derivative were reacted.

### Synthesis Example 19

A reaction vessel equipped with a thermometer and a stirrer was charged with 9.6 g of EO 3 mol adduct of glycerin, 30.7 g of 3-isocyanatopropyltriethoxysilane (manufactured by TCI), and 0.004 g of dibutyltin dilaurate, and the mixture was stirred at 60° C. for 18 hours to obtain 40 g of an alkoxysilane compound (A19). Incidentally, 100% of the hydroxyl groups at the terminals of the polyglycerol derivative were reacted.

### Synthesis Example 20

A reaction vessel equipped with a thermometer and a stirrer was charged with 10.1 g of EO 60 mol adduct of diglycerol, 3.5 g of 3-isocyanatopropyltriethoxysilane (manufactured by TCI), and 0.001 g of dibutyltin dilaurate, and the mixture was stirred at 60° C. for 16 hours to obtain 13.5 g of an alkoxysilane compound (A20). Incidentally, 100% of the hydroxyl groups at the terminals of the polyglycerol derivative were reacted.

### Synthesis Example 21

A reaction vessel equipped with a thermometer and a stirrer was charged with 10.0 g of PO 60 mol adduct of tetraglycerol, 4.1 g of 3-isocyanatopropyltriethoxysilane (manufactured by TCI), and 0.002 g of dibutyltin dilaurate, and the mixture was stirred at 60° C. for 18 hours to obtain 14 g of an alkoxysilane compound (A21). Incidentally, 100% of the hydroxyl groups at the terminals of the polyglycerol derivative were reacted.

### Example 1

1.20 g of the alkoxysilane compound (A1), 1.44 g of propylene glycol monomethyl ether, 0.33 g of water, and 0.12 g of a 1 wt % nitric acid aqueous solution were uniformly stirred and mixed to obtain a coating liquid. Then, the prepared mixed solution was applied to a PET film (COSMOSHINE A4300, manufactured by Toyobo Co., Ltd.) with a film thickness of 100 μm using an applicator (250 μm, Coating Tester Co., Ltd.). The applied coating film was air-dried at room temperature for 1 hour or more, and then allowed to stand in a dryer (SPHH-101, manufactured by ESPEC CORP.) set at 80° C. for 30 minutes to obtain a cured coating film.

### Examples 2 to 21

Coating liquids and cured coating films were prepared in the same manner as in Example 1 except that the alkoxysilane compound (A1) used in Example 1 was changed to the alkoxysilane compounds (A2) to (A21).

### Example 22

0.5 g of the alkoxysilane compound (A1), 0.5 g of methyl silicate (MS-51, manufactured by COLCOAT CO., LTD.), 1.00 g of propylene glycol monomethyl ether, 0.56 g of water, and 0.20 g of a 1 wt % nitric acid aqueous solution were uniformly stirred and mixed to obtain a coating liquid. Then, the prepared mixed solution was applied to a PET film (COSMOSHINE A4300, manufactured by Toyobo Co., Ltd.) with a film thickness of 100 μm using an applicator (250 μm, Coating Tester Co., Ltd.). The applied coating film was air-dried at room temperature for 1 hour or more, and then allowed to stand in a dryer (SPHH-101, manufactured by ESPEC CORP.) set at 80° C. for 30 minutes to obtain a cured coating film.

### Comparative Example 1

1.0 g of methyl silicate (MS-51, manufactured by COLCOAT CO., LTD.), 0.20 g of propylene glycol monomethyl ether, 1.43 g of water, and 0.10 g of a 1 wt % nitric acid aqueous solution were uniformly stirred and mixed to obtain a coating liquid. Then, the prepared mixed solution was applied to a PET film (COSMOSHINE A4300, manufactured by Toyobo Co., Ltd.) with a film thickness of 100 μm using an applicator (250 μm, Coating Tester Co., Ltd.). The applied coating film was air-dried at room temperature for 1 hour or more, and then allowed to stand in a dryer (SPHH-101, manufactured by ESPEC CORP.) set at 80° C. for 30 minutes to obtain a cured coating film.

Flexibility of the cured coating films of Examples 1 to 22 and Comparative Example 1 was evaluated by bending resistance and bending durability below.

### (Bending Resistance)

Evaluation was performed using a mandrel rod in accordance with JIS K5600-5-1 (cylindrical mandrel method). The cured coating film was set along the mandrel rod with its coated surface inside or outside, and bent until the facing surfaces became parallel. Then, the surface of the coating film was visually observed, and the outer diameter (mm) of the mandrel rod in which breakage or cracks occurred was recorded.

### (Bending Durability)

A cured coating film was attached and fixed to a clamshell bending tester (DMLHP-CS, manufactured by YUASA SYSTEM Co., Ltd.) with a tape, and an inner bending or outer bending continuous bending test was performed under the conditions of a bending diameter of 10 mm and a test speed of 30 rpm. The surface of the coating film was visually observed at the time of bending a predetermined number of times, and evaluation was performed based on the number of times of bending until breakage or cracks occurred. For the evaluation, a coating film with a film thickness of 10 μm was used.

### <Criterion>

⊙: No breakage or cracks after bending 10,000 times
◯: No breakage or cracks after bending 1,000 times, presence of breakage or cracks after bending 10,000 times
X: Presence of breakage or cracks after bending less than 1,000 times

The compounding compositions of Examples 1 to 22 and Comparative Example 1 are shown in Table 1. In addition, the evaluation results of bending resistance are shown in Table 2, and the evaluation results of bending durability are shown in Table 3. The bending durability shown in Table 3 was tested by extracting some examples.

TABLE 1

| | | | | | | Number of |
|---|---|---|---|---|---|---|
| | | | Average number of | | Residual | alkoxysilane |
| | | | moles of AO added | Number of | ratio of | groups |
| | | | (per hydroxyl group | hydroxyl groups | hydroxyl | (per |
| | Polyglycerol | AO | of polyglycerol) | of polyglycerol | groups | molecule) |
| A1 | Tetraglycerol | EO | 10 | 6 | 0% | 18 |
| A2 | Tetraglycerol | EO | 10 | 6 | 0% | 18 |
| A3 | Diglycerol | EO | 10 | 4 | 0% | 12 |
| A4 | Decaglycerol | EO | 10 | 12 | 0% | 36 |
| A5 | Tetraglycerol | EO | 1 | 6 | 0% | 18 |
| A6 | Tetraglycerol | EO | 1.17 | 6 | 0% | 18 |
| A7 | Tetraglycerol | EO | 1.33 | 6 | 0% | 18 |
| A8 | Tetraglycerol | EO | 2 | 6 | 0% | 18 |
| A9 | Tetraglycerol | EO | 2 | 6 | 25% | 13.5 |
| A10 | Tetraglycerol | EO | 2 | 6 | 50% | 9 |
| A11 | Tetraglycerol | EO | 10 | 6 | 25% | 13.5 |
| A12 | Tetraglycerol | EO | 10 | 6 | 50% | 9 |
| A13 | Tetraglycerol | EO | 2 | 6 | 0% | 18 |
| A14 | Tetraglycerol | EO | 2 | 6 | 0% | 18 |
| A15 | Tetraglycerol | EO | 2 | 6 | 0% | 18 |
| A16 | Diglycerol | EO | 2 | 4 | 0% | 12 |
| A17 | Triglycerol | EO | 2 | 5 | 0% | 15 |
| A18 | Decaglycerol | EO | 2 | 12 | 0% | 36 |
| A19 | Glycerol | EO | 1 | 3 | 0% | 9 |
| A20 | Diglycerol | EO | 15 | 4 | 0% | 12 |
| A21 | Tetraglycerol | PO | 10 | 6 | 0% | 18 |

TABLE 2

| | | | Example | | | | | | | | | | | | |
|---|---|---|---|---|---|---|---|---|---|---|---|---|---|---|---|
| | | | 1 | 2 | 3 | 4 | 5 | 6 | 7 | 8 | 9 | 10 | 11 | 12 | 13 |
| Compounding | Glass | A1 | 100 | | | | | | | | | | | | |
| composition | component | A2 | | 100 | | | | | | | | | | | |
| (Parts by | | A3 | | | 100 | | | | | | | | | | |
| weight) | | A4 | | | | 100 | | | | | | | | | |
| | | A5 | | | | | 100 | | | | | | | | |
| | | A6 | | | | | | 100 | | | | | | | |
| | | A7 | | | | | | | 100 | | | | | | |
| | | A8 | | | | | | | | 100 | | | | | |
| | | A9 | | | | | | | | | 100 | | | | |
| | | A10 | | | | | | | | | | 100 | | | |
| | | A11 | | | | | | | | | | | 100 | | |
| | | A12 | | | | | | | | | | | | 100 | |
| | | A13 | | | | | | | | | | | | | 100 |
| | | A14 | | | | | | | | | | | | | |
| | | A15 | | | | | | | | | | | | | |
| | | A16 | | | | | | | | | | | | | |
| | | A17 | | | | | | | | | | | | | |
| | | A18 | | | | | | | | | | | | | |
| | | A19 | | | | | | | | | | | | | |
| | | A20 | | | | | | | | | | | | | |
| | | A21 | | | | | | | | | | | | | |
| | | MS-51 | | | | | | | | | | | | | |
| | Ion exchange water | | 27 | 17 | 31 | 31 | 48 | 47 | 45 | 39 | 56 | 45 | 24 | 16 | 57 |
| | Acid | 1% Nitric acid | 10 | 20 | — | — | 30 | 30 | 30 | 30 | — | — | — | — | — |
| | | aqueous solution | | | | | | | | | | | | | |
| | | 5% Nitric acid | — | — | 6 | 6 | — | — | — | — | 6 | 6 | 6 | 6 | 6 |
| | | aqueous solution | | | | | | | | | | | | | |
| | Solvent | 1-Methoxy-2- | 120 | 400 | 400 | 400 | 400 | 400 | 400 | 400 | 400 | 400 | 400 | 400 | 400 |
| | | propanol | | | | | | | | | | | | | |
| Physical | Film | | 30 | 26 | 10 | 10 | 19 | 18 | 19 | 20 | 10 | 10 | 10 | 10 | 10 |
| properties | thickness | | | | | | | | | | | | | | |
| of coating | (μm) | | | | | | | | | | | | | | |

| | | | | | | | | | | | | | | |
|---|---|---|---|---|---|---|---|---|---|---|---|---|---|---|
| film | Bending resistance (mmø) | ≤2 | ≤2 | ≤2 | ≤2 | ≤2 | ≤2 | ≤2 | ≤2 | ≤2 | ≤2 | ≤2 | ≤2 | ≤2 |

| | | | | | | | | | | | | Comparative |
|---|---|---|---|---|---|---|---|---|---|---|---|---|
| | | | Example | | | | | | | | | Example |
| | | | 14 | 15 | 16 | 17 | 18 | 19 | 20 | 21 | 22 | 1 |
| Compounding | Glass | A1 | | | | | | | | | 50 | |
| composition | component | A2 | | | | | | | | | | |
| (Parts by | | A3 | | | | | | | | | | |
| weight) | | A4 | | | | | | | | | | |
| | | A5 | | | | | | | | | | |
| | | A6 | | | | | | | | | | |
| | | A7 | | | | | | | | | | |
| | | A8 | | | | | | | | | | |
| | | A9 | | | | | | | | | | |
| | | A10 | | | | | | | | | | |
| | | A11 | | | | | | | | | | |
| | | A12 | | | | | | | | | | |
| | | A13 | | | | | | | | | | |
| | | A14 | 100 | | | | | | | | | |
| | | A15 | | 100 | | | | | | | | |
| | | A16 | | | 100 | | | | | | | |
| | | A17 | | | | 100 | | | | | | |
| | | A18 | | | | | 100 | | | | | |
| | | A19 | | | | | | 100 | | | | |
| | | A20 | | | | | | | 100 | | | |
| | | A21 | | | | | | | | 100 | | |
| | | MS-51 | | | | | | | | | 50 | 100 |
| | Ion exchange water | | 57 | 59 | 66 | 65 | 62 | 78 | 33 | 26 | 56 | 143 |
| | Acid | 1% Nitric acid | — | — | — | — | — | — | — | — | 20 | 10 |
| | | aqueous solution | | | | | | | | | | |
| | | 5% Nitric acid | 6 | 6 | 6 | 6 | 6 | 6 | 6 | 6 | | |
| | | aqueous solution | | | | | | | | | | |
| | Solvent | 1-Methoxy-2- | 400 | 400 | 400 | 400 | 400 | 400 | 400 | 400 | 100 | 20 |
| | | propanol | | | | | | | | | | |
| Physical | Film | | 10 | 11 | 10 | 10 | 11 | 11 | 10 | 10 | 26 | 10 |
| properties | thickness | | | | | | | | | | | |
| of coating | (μm) | | | | | | | | | | | |

| | | | | | | | | | | | |
|---|---|---|---|---|---|---|---|---|---|---|---|
| film | Bending resistance (mmø) | ≤2 | ≤2 | ≤2 | ≤2 | ≤2 | ≤2 | ≤2 | ≤2 | ≤2 | >10 |

TABLE 3

| | | | | | | | | | | | | Comparative |
|---|---|---|---|---|---|---|---|---|---|---|---|---|
| | | | Example | | | | | | | | | Example |
| | | | 2 | 3 | 4 | 8 | 13 | 14 | 15 | 19 | 21 | 1 |
| | | A2 | 100 | | | | | | | | | |
| | | A3 | | 100 | | | | | | | | |
| | | A4 | | | 100 | | | | | | | |
| | | A8 | | | | 100 | | | | | | |
| | | A13 | | | | | 100 | | | | | |
| | | A14 | | | | | | 100 | | | | |
| | | A15 | | | | | | | 100 | | | |
| | | A19 | | | | | | | | 100 | | |
| | | A20 | | | | | | | | | | |
| | | A21 | | | | | | | | | 100 | |
| | | MS-51 | | | | | | | | | | 100 |
| | Ion exchange water | | 17 | 31 | 31 | 39 | 57 | 57 | 59 | 78 | 26 | 143 |
| | Acid | 1% Nitric acid | 20 | — | — | 30 | — | — | — | — | — | 10 |
| | | aqueous solution | | | | | | | | | | |
| | | 5% Nitric acid | — | 6 | 6 | — | 6 | 6 | 6 | 6 | 6 | |
| | | aqueous solution | | | | | | | | | | |
| | Solvent | 1-Methoxy-2- | 400 | 400 | 400 | 400 | 400 | 400 | 400 | 400 | 400 | 20 |
| | | propanol | | | | | | | | | | |
| Physical | Film | | 10 | 10 | 10 | 10 | 10 | 10 | 10 | 10 | 10 | 10 |
| properties | thickness | | | | | | | | | | | |
| of coating | (μm) | | | | | | | | | | | |

| | | | | | | | | | | | |
|---|---|---|---|---|---|---|---|---|---|---|---|
| film | Bending resistance (ø = 10 mm) | ⊙ | ⊙ | ⊙ | ⊙ | ⊙ | ⊙ | ⊙ | ◯ | ⊙ | X |

In Examples 1 to 21 in which a cured coating film obtained from the (poly)glycerin-based alkoxysilane of the present invention was used, breakage or cracks did not occur even when the mandrel rod had an outer diameter of 2 mm in a bending resistance test, and bending resistance was excellent as compared with Comparative Example 1 in which a cured coating film obtained from a general alkoxysilane was used. By blending the (poly)glycerin-based alkoxysilane of the present invention with the low-flexibility alkoxysilane shown in Comparative Example 1 as in Example 22, the bending resistance was significantly improved. Further, in bending durability, no breakage or cracks was confirmed even when the cured coating film obtained from the (poly)glycerin-based alkoxysilane of the present invention was continuously bent 1,000 times or more. From these evaluation results, it became clear that the cured coating film using the glass component obtained from the (poly)glycerin-based alkoxysilane of the present invention has sufficient flexibility.

1. A glass component which is a compound having a (poly)glycerol skeleton with an average polymerization degree of 1 to 100 and contains a (poly)glycerol alkoxysilane having an alkoxysilyl group.

2. The glass component according to claim 1, wherein the (poly)glycerol alkoxysilane is obtained by reacting:
(poly)glycerol or a (poly)glycerol derivative; and
an alkoxysilane having a reactive functional group.

3. The glass component according to claim 2, wherein the (poly)glycerol or the (poly)glycerol derivative is represented by a structure of the following formula (1): 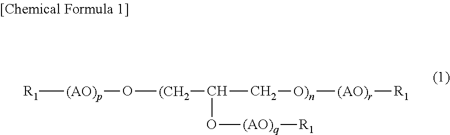
wherein n, p, q, and r each represent the number of repeating units, n is an integer of 1 to 100, and p, q, and r each are an integer of 0 to 50, AO represents an alkylene oxide having 1 to 4 carbon atoms, R1 is the same or different functional group, and is any reactive functional group selected from the group consisting of hydrogen, a thiol group, a (meth)acryloyl group, an epoxy group, and an allyl group, or a substituent containing the reactive functional group.

4. The glass component according to claim 2, wherein the alkoxysilane having a reactive functional group includes:
at least one reactive functional group selected from the group consisting of a vinyl group, an isocyanate group, a thiol group, a (meth)acryloyl group, an epoxy group, a hydroxyl group, an amino group, and a hydrosilyl group.

5. A glass formed by curing the glass component according to claim 1.

6. The glass component according to claim 3, wherein the alkoxysilane having a reactive functional group includes:
at least one reactive functional group selected from the group consisting of a vinyl group, an isocyanate group, a thiol group, a (meth)acryloyl group, an epoxy group, a hydroxyl group, an amino group, and a hydrosilyl group.

7. A glass formed by curing the glass component according to claim 2.

8. A glass formed by curing the glass component according to claim 3.

9. A glass formed by curing the glass component according to claim 4.

10. A glass formed by curing the glass component according to claim 6.
